(19) United States
(12) Patent Application Publication
(10) Pub. No.: US 2021/0007325 A1
(43) Pub. Date: Jan. 14, 2021

(54) PET TRACKING DEVICE

(71) Applicant: T-Mobile USA, Inc., Bellevue, WA (US)

(72) Inventor: Dolores Gill, Bellevue, WA (US)

(21) Appl. No.: 16/509,411

(22) Filed: Jul. 11, 2019

(51) Int. Cl. A01K 11/00; H04W 4/029; A01K 27/00; G06T 11/00

(52) U.S. Cl. CPC A01K 11/008; G06T 11/00; A01K 27/006; H04W 4/029

(57) ABSTRACT

A method of activating a pet tracking device to communicate with a wireless communication network is performed by a user equipment (UE). The method includes pairing the pet tracking device with UE, where pairing the pet tracking device with the UE includes receiving, at the UE via a first radio access technology (RAT), a unique device identifier of the pet tracking device. The UE then sends the unique device identifier to a pet tracking server of the wireless communication network. The pet tracking server is configured to enable the pet tracking device to communicate with the wireless communication network via a second RAT independent of the UE in response to receiving the unique device identifier.

### BACKGROUND

Preventing pets from straying away from human supervision or their home is a serious concern for many owners. Dogs, in particular, can wander away or stray without concern for their home when left alone outside of the home or when an entryway is left open. To ensure the safety of the pet and prevent the pet from becoming lost, most owners keep their pet indoors, enclosed within a fenced area or tethered to a location such that they are prohibited from wandering away. However, such means of containment are not foolproof, particularly if the animal is left unattended for long periods of time, where the animal may find a way to escape a fenced area, find holes in an electric fence or disengage from a tether device. For this reason, animal identification collars and/or microchips generally include the animal's and their owner's contact information, such that retrieval of the animal is possible after being corralled or taken in by another individual. This allows the owner to be contacted or authorities to locate the animal's home.

Basic animal collars and/or microchips are useful devices for identifying the animal and the owner's information; however, they are less than effective for locating the animal while it is still on the loose.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of a wireless communication network.

FIG. 2 illustrates examples of user equipment (UE).

FIG. 3 illustrates an example server.

FIG. 4 illustrates an example pet tracking device.

FIG. 5 is a flow diagram of an example process for activating a pet tracking device.

FIG. 6 is a flow diagram of an example process for selecting a radio access technology (RAT) for communicating positioning data by a pet tracking device.

FIG. 7 illustrates various RATs utilized by a pet tracking device for communicating positioning data.

FIG. 8 is a flow diagram of an example augmented reality process for displaying a marker to indicate the location of a pet tracking device.

FIG. 9 illustrates an example user interface for displaying a marker to indicate the location of a pet tracking device.

### DETAILED DESCRIPTION

Aspects of the present disclosure are directed to computing platforms (i.e., user equipment, server, etc.), computer-readable media, and processes for use with a pet tracking device.

A user device, or user equipment (UE), may be mobile or stationary and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station,” and variations thereof. Generally, UEs can communicate with a core network via the RAN, and through the core network, the UEs can be connected with external networks such as the Internet. Of course, other mechanisms of connecting to the core network and/or the Internet are also possible for the UEs, such as over wired access networks, Wi-Fi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

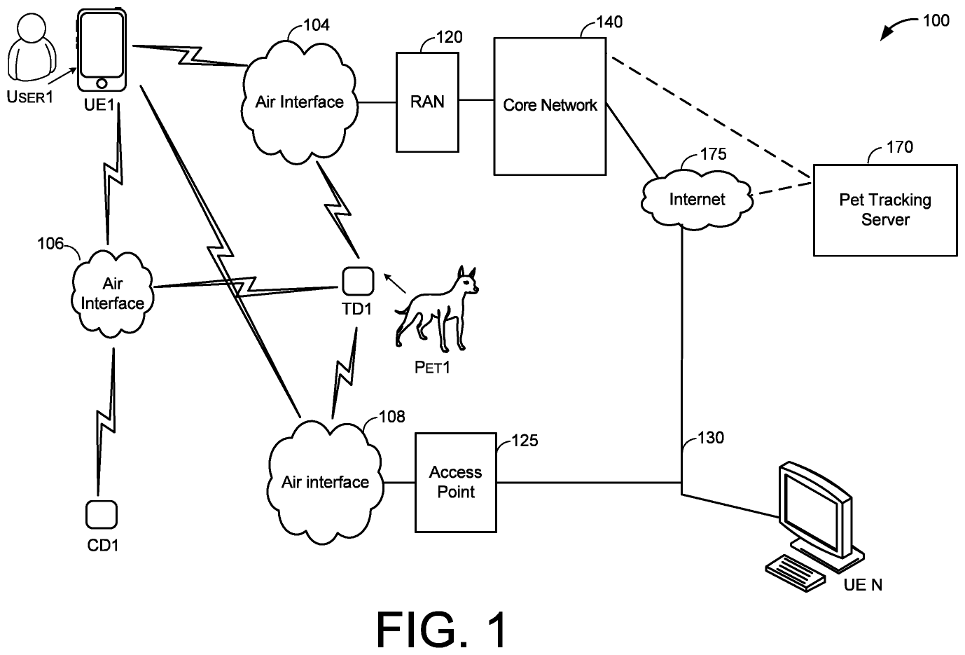

FIG. 1 illustrates a high-level system architecture of a wireless communication network 100 in accordance with various aspects. The wireless communication network 100 contains UEs 1 . . . N. The UEs 1 . . . N can include mobile phones, personal computers (e.g., a laptop computer, desktop computer, etc.), television receivers (e.g., a television, streaming device, digital video recorder, etc.), voice-activated virtual assistants, gaming consoles, and so on. For example, in FIG. 1, UE 1 is illustrated as a cellular touchscreen mobile phone or smartphone, and UE N is illustrated as a desktop computer or laptop.

The UE 1 is configured to communicate with an access network (e.g., the RAN 120, an access point 125, etc.) over a physical communications interface or layer, shown in FIG. 1 as air interfaces 104 and 108 and/or a direct wired connection 130. The air interface 104 can comply with a given cellular communications protocol (e.g., CDMA, EVDO, eHRPD, GSM, EDGE, W-CDMA, LTE, etc.), while the air interface 108 can comply with a wireless IP protocol (e.g., Wi-Fi, IEEE 802.11). The RAN 120 includes a plurality of access points that serve UEs over air interfaces, such as the air interface 104. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, The UE N is shown as connecting to the Internet 175 directly (i.e., separate from the core network 140, such as over an Ethernet connection of a Wi-Fi or an 802.11-based network). The Internet 175 can thereby function to bridge packet-switched data communications between the UE N and UE 1 via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve the UE 1 over a local wireless connection, such as IEEE 802.11 in an example. The UE N is shown as a desktop computer with a direct wired connection 130 to the Internet 175, such as a direct connection to a modem or router, which can correspond to the access point 125 itself in an example (e.g., for a Wi-Fi router with both wired and wireless connectivity).

The core network 140 is configured to support one or more communication services (e.g., Voice-over-Internet Protocol (VoIP)) sessions, Push-to-Talk (PTT) sessions, group communication sessions, social networking services, etc.) for UEs that can connect to the core network 140 via the RAN 120 and/or via the Internet 175, and/or to provide content (e.g., web page downloads) to the UEs.

Further illustrated in FIG. 1 is a pet tracking device TD1. In some aspects, the pet tracking device TD1 is wearable by a pet/animal such as being fixedly attached or integrated within a pet collar. As will be described in further detail below, the pet tracking device TD1 may include a positioning module that generates positioning data that indicates a location of the pet tracking device TD1. The pet tracking device TD1 may also include a communications device for transmitting the positioning data over one or more of the air interfaces 104, 106, and 108 according to one or more radio access technologies (RAT). For example, pet tracking device TD1 may be configured to transmit positioning data to a pet tracking server 170 via a first RAT, such as long term evolution (LTE) by way of air interface 104. In another example, pet tracking device TD1 may be configured to transmit positioning data to pet tracking server 170 via a second RAT, such as Wi-Fi, by way of air interface 108. In still another example, pet tracking device TD1 may be configured to transmit positioning data to the UE 1 via a third RAT, such as Bluetooth and/or Bluetooth Low-energy (BLE), by way of air interface 106. Pet tracking device TD1 may also be configured to transmit positioning data to a charging device CD1 via the third RAT (Bluetooth) by way of air interface 106.

Charging device CD1 is a device for charging a battery included in the pet tracking device TD1. In one aspect, charging device CD1 may be a wall charger configured to recharge the battery of the pet tracking device TD1 in response to the battery and/or pet tracking device TD1 itself, is attached to the charging device CD1. Charging device CD1 may also be configured to periodically generate a beacon signal (e.g., BLE beacon) for use by the pet tracking device TD1 to determine its proximity to the charging device CD1.

Referring to FIG. 1, pet tracking server 170 is shown as connected to the Internet 175, the core network 140, or both. The pet tracking server 170 can be implemented as a plurality of structurally separate servers, or alternatively may correspond to a single server. As will be described below, pet tracking server 170 may include a pet tracking module for collecting positioning data from one or more pet tracking devices TD1 and for reporting the positioning data to one or more UEs (e.g., UEs 1 . . . N).

According to aspects of the present disclosure, one or more of the various UEs 1-N illustrated in FIG. 1 may include a locally-installed pet tracking application. In other aspects, the pet tracking application is network (e.g., web) based. The pet tracking application may support the tracking and activity monitoring of several pets that each have an associated pet tracking device TD1. As mentioned above, the pet tracking device TD1 may communicate positioning data to the pet tracking server 170 via a RAT such as LTE by way of air interface 104, RAN 120, and core network 140. However, before communicating over a RAT such as LTE, the pet tracking device TD1 must first be activated with the pet tracking server 170. Accordingly, the pet tracking application may further include an onboarding feature for pairing the pet tracking device TD1 with the UE 1. In some aspects, pairing the pet tracking device TD1 with the UE 1 is done via BLE over the air interface 106 and includes receiving, at the UE 1, an international mobile equipment identity (IMEI) number of the pet tracking device TD1. Once the UE 1 obtains the IMEI number of the pet tracking device TD1, the UE1 may register the pet tracking device TD1 with the pet tracking server 170, which then enables the pet tracking device TD1 to communicate within the wireless communications network 100 (e.g., via LTE).

In various embodiments, the pet tracking server 170 may access cloud infra services that may be made accessible via an integrated cloud infrastructure. The cloud infrastructure not only provides access to cloud infra services such as providing computing resources to support data portioning, scaling, security, and backup but also to billing services and other monetization services. The cloud infrastructure may provide additional service abstractions such as Platform as a Service (PaaS), Infrastructure as a Service (IaaS), and/or Software as a Service (SaaS), depending upon embodiments.

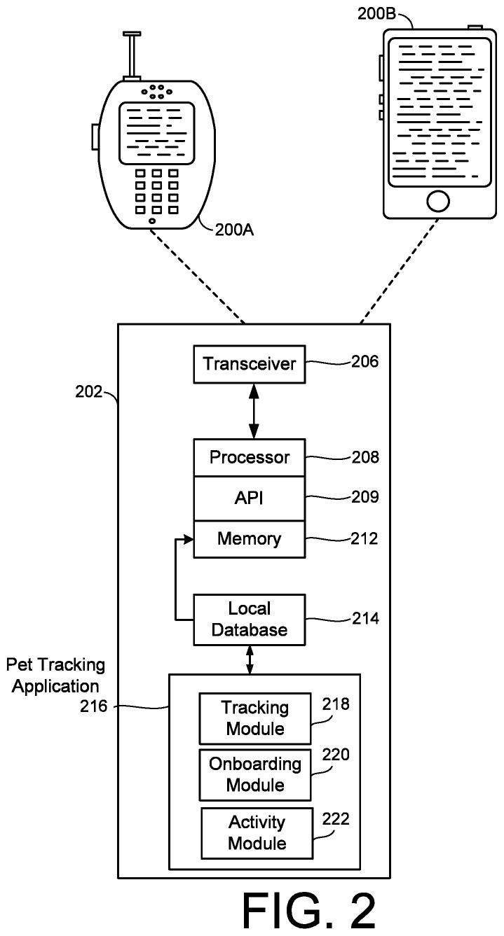

FIG. 2 illustrates examples of UEs (i.e., user devices) in accordance with embodiments of the present disclosure. UEs 200A and 200 B are possible implementations of any of the UEs 1-N of FIG. 1. The various device types illustrated in FIG. 2 include a mobile phone (e.g., UE 200A) and smartphone (e.g., UE 200B).

The UEs 200A and 200B may also be referred to as cellular phones or portable telephones that can make and receive calls over a radio frequency link while the user is moving within a telephone service area.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., pet tracking server 170, web URLs, etc.). The platform 202 can also independently execute locally stored applications without RAN interaction. The platform 202 can include a transceiver 206 operably coupled to a processor 208 (e.g., an application specific integrated circuit (ASIC) or another microprocessor, logic circuit, data processing device, etc.). The processor 208 executes the application programming interface (API) 209 layer that interfaces with any resident programs in the memory 212 of the wireless device The memory 212 can be comprised of read-only or random-access memory (RAM and ROM), electrically erasable programmable read-only memory (EEPROM), flash cards, or any memory common to computer platforms. The platform 202 also can include a local database 214 that can store applications not actively used in memory 212, as well as other data. The local database 214 is typically a flash memory cell but can be any secondary storage device as known in the art, such as magnetic media, EEPROM, optical media, tape, soft or hard disk, or the like.

The platform 202 may also provide one or more motion and/or position determination functionalities. Such motion and/or position determination capabilities may be provided using digital cellular positioning techniques and/or Satellite Positioning Systems (SPS). Additionally, the platform 202 may include one or more motion sensors (e.g., simple switches, accelerometers, angle sensors, etc.), or other onboard devices to provide relative position, velocity, acceleration, and/or orientation information of the UE, itself.

Accordingly, an embodiment of the invention can include a UE (e.g., the UE 200A-B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the platform 202 is illustrated as including a pet tracking application 216. In general, the pet tracking application 216 may allow users to keep track of their pets in real time. The pet tracking application 216 may also allow users to review previous pet activity, such as distance traveled over a time period (e.g., 24 hours), rest time, steps taken, calories burned, etc.

The processor 208 may execute instructions and perform tasks under the direction of software components that are stored in memory 212. For example, the memory 212 may store various software components that are executable or accessible by the one or more processors 208. The various components may be the pet tracking application 216 including a tracking module 218, an onboarding module 220, and an activity module 224.

The tracking module 218, onboarding module 220, and activity module 224 may include routines, program instructions, objects, and/or data structures that perform particular tasks or implement particular abstract data types. For example, the tracking module 218 may include one or more instructions, which when executed by the one or more processors 208 direct the UE to perform operations related to receiving, processing, and presenting positioning data generated by a pet tracking device (e.g., pet tracking device TD1 of FIG. 1).

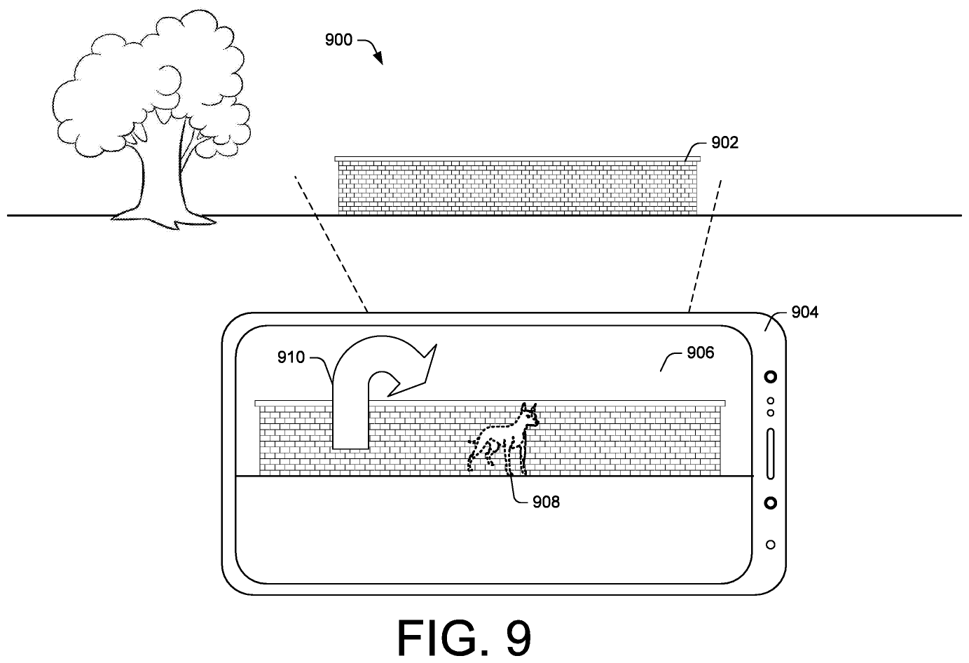

In some aspects, the tracking module 218 may be configured to display a pet tracking device's real-time location. The tracking module 218 may display the pet tracking device's location by way of a marker on a map, by display the global positioning system (GPS) coordinates of the pet tracking device, and/or by an augmented reality function described further below with reference to FIG. 9. The tracking module 218 may also be configured to receive and display exit geofence notifications to alert the user that a pet has exited a previously-defined geofence. In some aspects, the tracking module 218 may also provide navigation directions to direct a user to the current location of their pet based on the positioning data generated by the pet tracking device.

The onboarding module 220 may include one or more instructions, which when executed by the one or more processors 208 direct the UE to perform operations related to activating a pet tracking device (e.g., pet tracking device TD1 of FIG. 1) to communicate with a wireless communication network 100. For example, in one aspect, upon powering on the pet tracking device TD1, the pet tracking device TD1 may attempt to pair (e.g., via BLE) with the UE 1. Pairing the UE1 with the pet tracking device TD1 may include receiving at the UE 1, a unique device identifier (e.g., IMEI number) of the pet tracking device TD1. The onboarding module 220 may then present a user interface to allow the user to create a pet profile associated with that particular pet tracking device TD1. In some examples, the pet profile may include a name of the pet, a photo of the pet, a weight of the pet, and/or an identification of the pet type (e.g., dog, cat, other, etc.).

The onboarding module 220 may also provide an interface to allow the user to define one or more geofences associated with the pet tracking device TD1 (e.g., name, address, and/or six-point or circular boundary).

Once the pet profile is completed, the onboarding module 220 may upload the unique device identifier of the pet tracking device TD1, to the pet tracking server 170, where the pet tracking server 170 then enables the pet tracking device TD1 to communicate via the wireless communications network 100 (e.g., enable LTE communication). In addition to uploading the unique device identifier of the pet tracking device TD1, the UE may also upload a subscriber indicia of a user associated with the UE. That is, the subscriber indicia may include a user ID, an IMEI number of the UE, or other indicia to allow a mobile network operator (MNO) of the wireless communication network 100 to identify the user as a current subscriber. The MNO may then associate the unique device identifier of the pet tracking device TD1 with a current subscriber account for billing or for providing other services associated with the use of pet tracking device TD1.

The activity module 222 may include one or more instructions, which when executed by the one or more processors 208 direct the UE to perform operations related to receiving, processing, and displaying additional data related to current and/or past pet activity. For example, in some aspects, the pet tracking device TD1 may include various sensors to determine not only a location of the pet tracking device but also movement (e.g., by way of an accelerometer). Thus, the activity module 222 may receive this additional data from the pet tracking server 170. In one aspect, the activity module 222 may present, via a display of the UE, an animation that shows previous movements of their pet (e.g., a map with an animated route of the pet's daily movements). In addition, the activity module 222 may display one or more statistics related to their pet's activity, such as distance traveled, steps taken, amount of time active, amount of time at rest, etc.

In another aspect, the activity module 222 may be configured to allow a user to share an activity snapshot (e.g., one or more pet statistics) with one or more social media services.

Thus, in some aspects, the processor 208, memory 212, API 209, local database 214, and pet tracking application 216 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. Voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

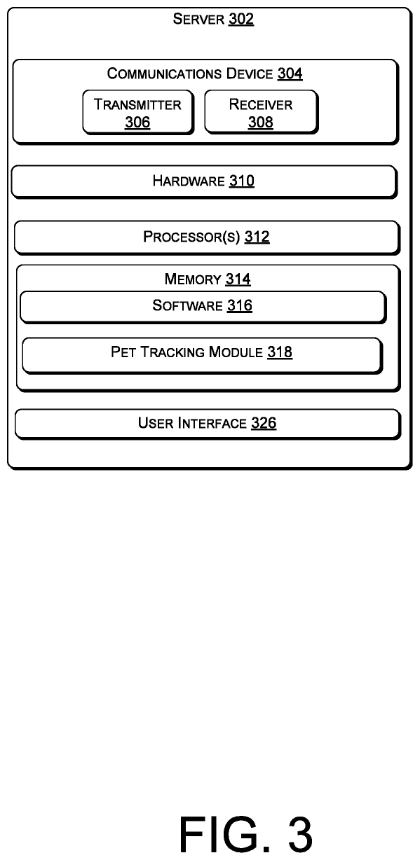

FIG. 3 illustrates an example server 302. Server 302 is one possible implementation of pet tracking server 170 of FIG. 1. The components illustrated in FIG. 3 may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The server 302 may include at least one communication device (represented by the communication device 304) for communicating with other nodes. For example, the communication device 304 may comprise a network interface that is configured to communicate with one or more network entities via a wire-based or wireless links. In some aspects, the communication device 304 may be implemented as a transceiver configured to support wire-based or wireless signal communication. This communication may involve, for example, sending and receiving: messages, parameters, or other types of information. Accordingly, in the example of FIG. 3, the communication device 304 is shown as comprising a transmitter 306 and a receiver 308.

The server 302 may also include other components that may be used in conjunction with the operations as taught herein. For example, the server 302 may include hardware 310, one or more processors 312, memory 314, and a user interface 326.

The hardware 310 may include additional hardware interfaces, data communications, and/or data storage hardware. For example, the hardware interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

In addition, the server 302 may include a user interface 326 for providing indications (e.g., audible and/or visual indications) to a user and/or for receiving user input (e.g., upon user actuation of a sensing device such a keypad, a touch screen, a microphone, and so on).

The memory 314 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or another transmission mechanism. As defined herein, computer-readable storage media do not consist of and are not formed exclusively by, modulated data signals, such as a carrier wave.

The processor 312 of server 302 may execute instructions and perform tasks under the direction of software components that are stored in memory 314. For example, the memory 314 may store various software components that are executable or accessible by the one or more processors 312 of the application server 302. The various components may include software 316 and a pet tracking module 318.

The software 316 and pet tracking module 318 may include routines, program instructions, objects, and/or data structures that perform particular tasks or implement particular abstract data types. For example, the pet tracking module 318 may include one or more instructions, which when executed by the one or more processors 312 direct the server 302 to perform operations related to the collection of positioning and other data generated by pet tracking devices, as well as facilitating the onboarding of a newly activated pet tracking device.

In operation, the pet tracking module 318 may receive onboarding data from one or more UEs (e.g., pet tracking application 216 of FIG. 2). In some aspects, the onboarding data includes the unique device identifier (e.g., IMEI) of the pet tracking device TD1, as well as a subscriber indicia (e.g., user ID) of a user associated with the UE. In addition, the onboarding data may include the pet profile data entered by the user by way of the pet tracking application 216. In response to receiving the onboarding data, the server 302 may store the onboarding data (e.g., to memory 314) and then enable the pet tracking device TD1 to communicate (e.g., via LTE) with the wireless communication network 100. In various embodiments, the server 302 may communicate with a database comprising a list of authorized pet tracking devices to enable the pet tracking device TD1 to connect with the network or establish a data session.

In some aspects, the pet tracking module 318 may also be configured to receive positioning data from one or more pet tracking devices (e.g., pet tracking device TD1) and store the positioning data into memory 314 and/or one or more databases (not shown). In some aspects, access to the positioning data stored in memory 314 may be subject to access controls consistent with current privacy laws.

As mentioned above, with reference to FIG. 1, the pet tracking device TD1 may be configured to communicate via several RATs (e.g., BLE, Wi-Fi, LTE, etc.). Thus, receiving positioning data at the pet tracking module 318 may include receiving the pet tracking device positioning data via the internet 175, via the core network 140, and/or via a corresponding UE1. Furthermore, pet tracking module 318 may be configured to communicate with the pet tracking application 216 of a UE to provide the UE with the stored positioning data and/or other data relating to a pet tracking device TD1.

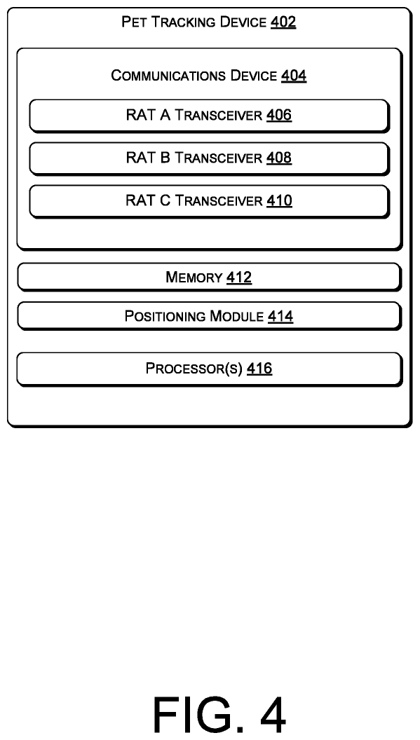

FIG. 4 illustrates an example pet tracking device 402. Pet tracking device 402 is one possible implementation of the pet tracking device TD1 of FIG. 1. In the example of FIG. 4, the communication device 404 of the pet tracking device 402 includes a RAT A transceiver 406 that is configured to operate in accordance with one RAT (e.g., Bluetooth and/or BLE). The communication device 404 also includes a RAT B transceiver 408 that is configured to operate in accordance with another RAT (e.g., LTE). Further shown as included in the example communication device 404 is a RAT C transceiver 410 that is configured to operate in accordance with yet another RAT (e.g., Wi-Fi). As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing) Further, as used herein, the term “co-located” (e.g., radios, access points, transceivers, etc.) may refer to one of the various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The RAT transceivers 406-410 may provide different functionalities and may be used for different purposes. As an example, the RAT A transceiver 406 may operate in accordance with Bluetooth technology to pair with a UE and to provide a unique device identifier to the UE, while the RAT B transceiver 408 may operate in accordance with LTE technology to communicate positioning data and other data to pet tracking server 170.

The components illustrated in FIG. 4 may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The pet tracking device 402 may also include other components that may be used in conjunction with the operations as taught herein. For example, the pet tracking device 402 may include, memory 412, a positioning module 414, and one or more processors 416.

The positioning module 414 of the pet tracking device 402 may include hardware and optionally software to provide location and/or position determination capabilities for the pet tracking device 402. For example, the positioning module 414 may include a Satellite Positioning Systems (SPS) receiver for determining current positioning data of the pet tracking device 402. In addition, the positioning module 414 may include one or more receivers for implementing one or more digital cellular positioning techniques. In yet another aspect, the positioning module 414 may include one or more motion sensors (e.g., simple switches, accelerometers, angle sensors, etc.), where such onboard motion sensors may be used to provide relative position, velocity, acceleration, and/or orientation information of the pet tracking device 402.

The processor 416 may execute instructions and perform tasks under the direction of software components that are stored in memory 412. The various components may include functions related to pairing the pet tracking device 402 with a UE (e.g., and providing unique device identifier), RAT determination (e.g., whether to utilize BLE, Wi-Fi, or LTE for reporting positioning data), and/or power management, etc.

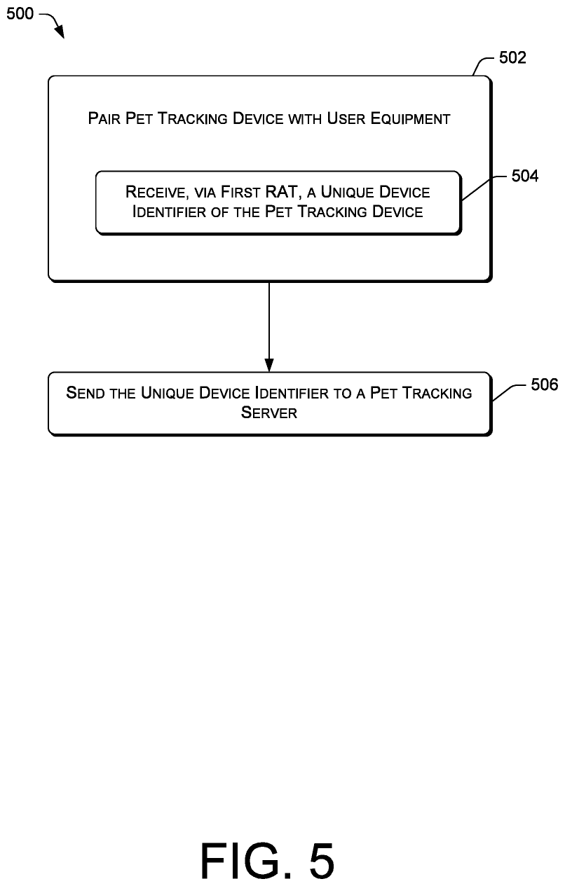

FIG. 5 is a flow diagram of an example process 500 for activating a pet tracking device. Process 500 is one possible process performed by a UE, such as UE1 of FIG. 1 and/or platform 202 of FIG. 2. In some aspects, process 500 represents at least a portion of the onboarding function implemented by onboarding module 220 of FIG. 2.

As mentioned above, in some aspects, the pet tracking device TD1 is configured to automatically attempt to pair with a UE in response to being powered on. Thus, process block 502 includes pairing the pet tracking device with UE1. In one aspect, pairing the pet tracking device TD1 with UE1 includes establishing a Bluetooth (BLE) connection between pet tracking device TD1 and UE1. Once a connection is established, process block 504 includes receiving, at the UE1, a unique device identifier (e.g., IMEI number) of the pet tracking device TD1. Furthermore, the UE1 may receive the unique device identifier via a first RAT, such as Bluetooth or BLE.

Next, in process block 506, UE1 sends the unique device identifier to a pet tracking server 170. As mentioned above, the UE1 may also send a subscriber indicia as well as additional pet profile information entered by the user (e.g., pet name, photo, geofence, etc.). Thus, in response to receiving the unique device identifier, the pet tracking server 170 may enable the pet tracking device TD1 to communicate with the wireless communication network 100 via a second RAT (e.g., LTE) independent of the UE. That is, once enabled, the pet tracking device TD1 may communicate with the wireless communication network 100 without the need to communicate further with the UE.

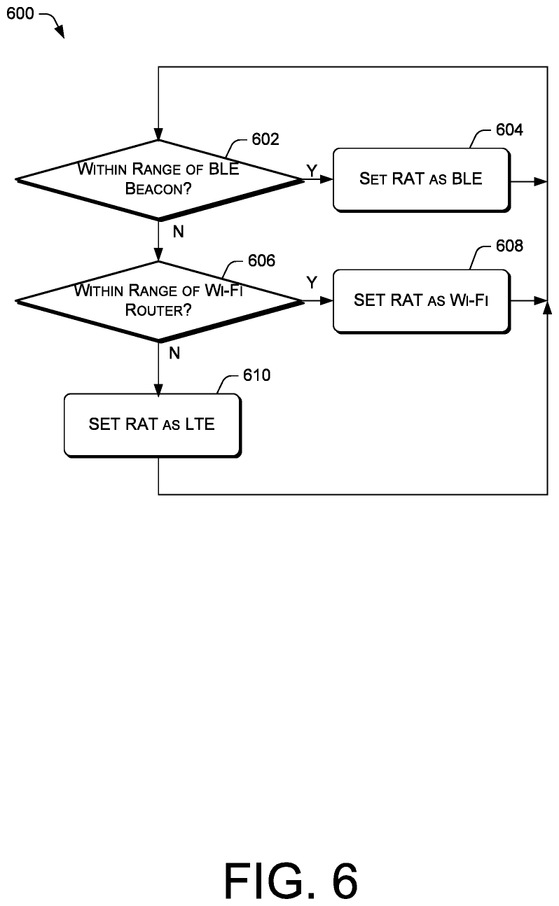

FIG. 6 is a flow diagram of an example process 600 for selecting a radio access technology (RAT) for communicating positioning data by a pet tracking device. Process 600 illustrates one possible process performed by a pet tracking device, such as the pet tracking device TD1 of FIG. 1. As mentioned above, the pet tracking device may include a battery. Thus, power management may be useful for extending the operational time for the pet tracking device to ensure continued operation. Accordingly, in some aspects, the pet tracking device may include a power management scheme that includes, in part, selecting from among several RATs based on distance and/or availability, as well as an amount of power each RAT requires for communication. For example, the pet tracking device may select a certain RAT for reporting positioning data only if no other lower power RATs are available. Thus, process 600 illustrates one possible power management scheme.

As shown in FIG. 6, process block 602 includes the pet tracking device determining whether it is in range of a BLE beacon generated by the charging device CD1. In one example, determining whether the pet tracking device is within range of the BLE beacon may include determining that a connection has failed. In another example, determining whether the pet tracking device is in range of the BLE beacon may include determining a received signal strength of the BLE beacon. In yet another example, determining whether the pet tracking device is in range of the BLE beacon may be based on a calculated distance between the pet tracking device TD1 and the charging device CD1 as determined by one or more position determinations (e.g., via GPS). If in process block 602, the pet tracking device determines that it is within range of the BLE beacon, then process block 604 includes setting the current RAT for the pet tracking device as BLE. Setting the current RAT as BLE may include communicating the positioning data via BLE to the charging device CD1 and/or the UE1 via air interface 106, as shown in FIG. 1. If the positioning data is communicated to the charging device CD1, the charging device CD1 may then forward the positioning data to the UE1. Thus, in some aspects, charging device CD1 may act as a range extender for Bluetooth communications received from the pet tracking device TD1. Once the positioning data is received at the UE1, either directly from the pet tracking device TD1, or from the charging device CD1, the UE1 may then send the positioning data to the pet tracking server 170. In some aspects, the UE1 is prevented from storing or otherwise saving the positioning data and, thus, may act as a conduit for simply forwarding the receiving positioning data from the pet tracking device TD1 to the pet tracking server 170.

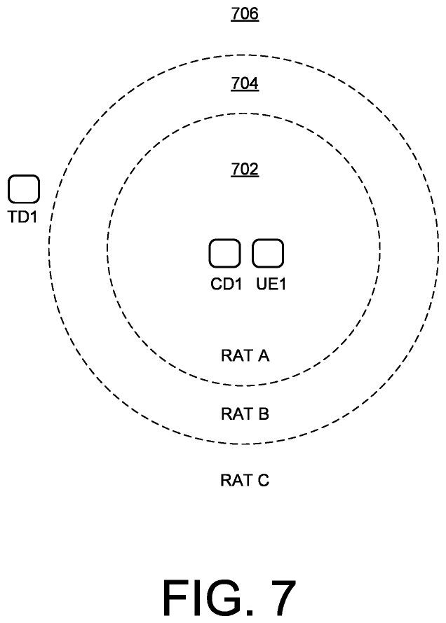

Returning now to FIG. 7, if in process block 602 it is determined that the pet tracking device is not within the range of the BLE beacon, then process block 606 includes the pet tracking device determining whether it is in range of a Wi-Fi router (e.g., access point 125 of FIG. 1). Determining whether the pet tracking device is within range of the Wi-Fi router may be based on a failed Wi-Fi connection, a calculated distance, and/or of a received signal strength of any Wi-Fi signals. If the pet tracking device TD1 is within range of the Wi-Fi router, process block 608 includes setting the current RAT as Wi-Fi (e.g., communicating positioning data over Wi-Fi).

If, however, the pet tracking device TD1 is not within the range of the Wi-Fi-router, then process block 610 includes setting the current RAT as LTE.

Although process 600 illustrates an example process performed by a pet tracking device, the selection of the RAT with which to communicate the positioning data may dictate the way in which the UE receives the positioning data. For example, if the pet tracking device selects Bluetooth as the current RAT, the UE may receive positioning data either directly from the pet tracking device or via the charging device CD1. If, however, the pet tracking device selects Wi-Fi as the current RAT, then the UE may receive the positioning data from a Wi-Fi router. In yet another example, if the pet tracking device selects LTE as the current RAT, then the UE may receive the positioning data from the pet tracking server 170.

FIG. 7 illustrates various RATs utilized by a pet tracking device TD1 for communicating positioning data. FIG. 7 illustrates various regions represented as regions 702, 704, and 706. In one aspect, the regions are defined with respect to the charging device CD1. That is, region 702 may represent a region that is a first distance from the charging device CD1, whereas regions 704 and 706 represent regions that are further distances from the charging station CD1. However, in other examples, the regions may be defined with respect to the UE1. That is, in some examples, the UE1 may be configured to generate a BLE beacon signal with which the pet tracking device TD1 determines which RAT to utilize.

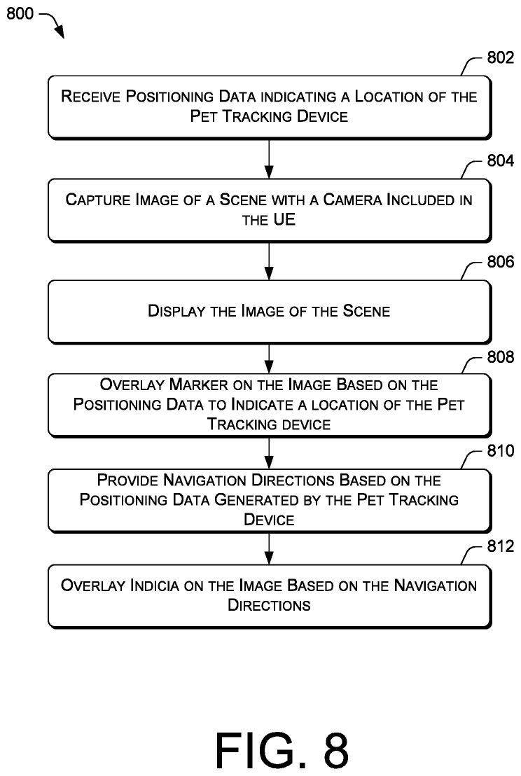

FIG. 8 is a flow diagram of an example augmented reality process 800 for displaying a marker to indicate the location of a pet tracking device. The process 800 is one example process performed by the pet tracking device TD1 of FIG. 1 and/or the platform 202 of FIG. 2. The process 800 will be described with reference to FIGS. 1, 2, 8, and 9.

In a process block 802, the tracking module 218 of the platform 202 receives positioning data indicating a location of the pet tracking device TD1. In one example, the positioning data is received from pet tracking server 170. The positioning data of the pet tracking device TD1 may be used to mark the location of a user's pet on a map that can be displayed on the UE 904. For example, an icon, tag, push pin, text, or other indicators may be displayed on the map to mark the location of the pet. Additionally, or alternatively, a visual positioning system (VPS) may be implemented. For instance, FIG. 9 illustrates a scene 900 where the pet is located. However, the user's view of the pet may be obstructed by way of a tree, building, or in the example of FIG. 9, a wall 902. Thus, despite knowing the general location of the pet, the user may still be unable to determine the precise location of the animal.

Accordingly, the pet tracking application 216 may provide an augmented reality function to further aid in locating the user's pet. By way of example, in a process block 804, an image 906 of a scene is captured with a camera (not shown) included in the UE 904. The image 906 is then displayed (i.e., in a process block 806) on a screen of the UE 904. In a process block 808, the pet tracking application 216 may then overlay a marker 908 on the image 906 based on the positioning data received to indicate the location of the pet tracking device TD1. In the example of FIG. 9, the marker 908 is displayed as an animal outline. However, in other examples, the marker 908 may be displayed as one or more other indicators, such as an icon, tag, push pin, text, etc.

In a process block 810, the tracking module 218 of the pet tracking application 216 may provide navigation directions to direct the user to the current location of the pet based on the positioning data generated by the pet tracking device TD1. In a process block 812, the pet tracking application 216 may overlay an indicia 910 on the image 906 based on the navigation directions. In the example of FIG. 9, the indicia 910 may be displayed as one or more indicators, such as an arrow, text, etc. In some aspects, the indicia 910 can include names of landmarks, buildings, streets, and/or so forth. Additionally, the indicia 910 can visually indicate regions that may be defined with respect to the location of the UE 904 relative to the pet tracking device TD1 as described in FIG. 7. In this way, the indicia 910 may inform the user the RAT that may be selected by the pet tracking device TD1 to communicate its positioning data to the UE 904.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A computer-implemented method of activating a pet tracking device to communicate with a wireless communication network, the method comprising:
pairing the pet tracking device with a user equipment (UE), wherein pairing the pet tracking device with the UE includes receiving, at the UE via a first radio access technology (RAT), a unique device identifier of the pet tracking device;
sending, by the UE, the unique device identifier and a user ID associated with the UE to a pet tracking server of the wireless communication network, wherein the pet tracking server is configured to associate the unique device identifier with the user ID and enable the pet tracking device to communicate with the wireless communication network via a second RAT independent of the UE in response to receiving the unique device identifier; and
receiving, at the UE from the tracking server, positioning data of the pet tracking device, the positioning data received at the tracking server by way of at least the second RAT and stored in association with the unique device identifier.

2. The computer-implemented method of claim 1, wherein the first RAT comprises Bluetooth.

3. The computer-implemented method of claim 1, wherein the second RAT comprises long term evolution (LTE).

4. The computer-implemented method of claim 1, wherein the second RAT comprises Wi-Fi.

5. The computer-implemented method of claim 1, wherein the unique device identifier comprises an International Mobile Equipment Identity (IMEI) number of the pet tracking device.

6.-8. (canceled)

9. The computer-implemented method of claim 1, wherein the positioning data is provided by the pet tracking device to a charging device associated with the pet tracking device and the charging device is configured to communicate the positioning data to the tracking server.

10. The computer-implemented method of claim 1, wherein the positioning data is provided by the pet tracking device to a Wi-Fi access point and the Wi-Fi access point is configured to communicate the positioning data to the tracking server.

11. The computer-implemented method of claim 1, wherein the positioning data is provided by the pet tracking device to the pet tracking server and the pet tracking device is configured to communicate the positioning data to the pet tracking server via the second RAT comprising LTE.

12. The computer-implemented method of claim 1, further comprising:
capturing an image of a scene with a camera included in the UE;
displaying the image of the scene via a pet tracking application installed on the UE; and
overlaying a marker on the image based on the positioning data to indicate the location of the pet tracking device within the scene.

13. A user equipment (UE), comprising:
at least one processor; and
at least one memory coupled to the at least one processor, the at least one memory having instructions stored therein, which when executed by the at least one processor, direct the UE to:
pair the UE with a pet tracking device, wherein the instructions to pair the UE with the pet tracking device includes instructions to receive, at the UE via a first radio access technology (RAT), a unique device identifier of the pet tracking device;
send the unique device identifier and a user ID associated with the UE to a pet tracking server of a wireless communication network, wherein the pet tracking server is configured to associate the unique device identifier with the user ID and enable the pet tracking device to communicate with the wireless communication network via a second RAT independent of the UE in response to receiving the unique device identifier; and
receive, at the UE from the tracking server, positioning data of the pet tracking device, the positioning data received at the tracking server by way of at least the second RAT and stored in association with the unique device identifier.

14. The UE of claim 13, wherein the unique device identifier comprises an International Mobile Equipment Identity (IMEI) number of the pet tracking device.

15.-16. (canceled)

17. The UE of claim 13, wherein the pet tracking device is configured to communicate the positioning data to a charging device, and wherein the second RAT comprises Bluetooth.

18. The UE of claim 13, wherein the pet tracking device is configured to communicate positioning data to the pet tracking server, and wherein the second RAT comprises LTE.

19. The UE of claim 13, wherein the instructions further direct the UE to:
receive the positioning data indicating a location of the pet tracking device;
capture an image of a scene with a camera included in the UE;
display the image of the scene via a pet tracking application installed on the UE; and
overlay a marker on the image based on the positioning data to indicate the location of the pet tracking device within the scene.

20. One or more non-transitory computer-readable media storing computer-executable instructions, which when executed by the at least one processor of user equipment (UE), direct the UE to:
pair the UE with a pet tracking device, wherein the instructions to pair the UE with the pet tracking device includes instructions to receive, at the UE via Bluetooth, a unique device identifier of the pet tracking device;
send the unique device identifier and a user ID associated with the UE to a pet tracking server of a wireless communication network, wherein the pet tracking server is configured to associate the unique device identifier with the user ID and enable the pet tracking device to communicate with the wireless communication network via Long Term Evolution (LTE) communication independent of the UE in response to receiving the unique device identifier; and
receive positioning data of the pet tracking device from the pet tracking server in response to the LTE communication being selected by the pet tracking device to communicate with the pet tracking server.

21. The computer-implemented method of claim 12, wherein the marker is displayed as an animal outline.
